(19) United States
(12) Patent Application Publication
(10) Pub. No.: US 2025/0204318 A1
(43) Pub. Date: Jun. 26, 2025

(54) ARRANGEMENT INTRODUCED IN PLATFORM FOR AGRICULTURAL CROP HARVEST

(71) Applicant: Renata Pinto BASTIDAS, Lucas do Rio Verde (BR)

(72) Inventor: Paulo Roberto TEIXEIRA, Lucas do Rio Verde (BR)

(21) Appl. No.: 18/391,381

(22) Filed: Dec. 20, 2023

(51) Int. Cl. A01D 45/02

(52) U.S. Cl. CPC A01D 45/025

(57) ABSTRACT

An arrangement introduced in platform for agricultural crop harvest, for separating the ear of the plant which eliminates almost completely the husks and crop residues which enter the internal perimeter of the equipment. This results in a lower power demand of the agricultural machine or implement, consequently less fuel consumption, as well as the leaves and disposable parts of the plant on the plantation bed. When they enter the processing perimeter of the agricultural machine or implement, they have a high abrasive power which generates premature wear of the internal sets and components.

### FIELD OF THE INVENTION

The present invention is related to the field of agricultural machines and implements, more particularly agricultural harvesting platforms for crops, such as maize, bringing as main advantage in relation to the systems known from the state of the art the fact that it comprises a device for separating the ear of the plant which eliminates almost completely the husks and crop residues which enter the internal perimeter of the equipment. This results in a lower power demand of the agricultural machine or implement, consequently less fuel consumption, as well as the leaves and disposable parts of the plant on the plantation bed. When they enter the processing perimeter of the agricultural machine or implement, they have a high abrasive power which generates premature wear of the internal sets and components.

### BACKGROUND OF THE INVENTION

Agricultural machines and implements for perennial or annual crop harvesting are widely known in the state of the art. In this type of implement the plant is usually directed to a platform, which as considered herein is used for crop cutting and harvesting, more concretely that of maize.

Maize harvesting machines are constituted by an implement, towed by a tractor unit or self-propelled, so that a fairing, built from known and suitable flexible material, directs the plant to a reaping and cleaning set, for subsequent collecting of the ears into the machine or implement where they will be processed.

In the implements known to the state of the art, the fairings comprise a spacing between each other forming a channel with selective connection through the plates, wherein the plant stalk enters. Subsequently there is a set of rolls arranged inferiorly and rotatably for cutting the agricultural crop. These rolls are distanced so as to mutually operate for cutting the plant stalk. In a known configuration, these rolls are conceived by a helical pitch at their end portion, relative to the dislocation direction of the agricultural machine or implement, subsequently these rolls comprise a series of fins, knives, or blades, which can be sharpened at their border portions for cutting the agricultural crop.

When working, once the plant stalk is cut it falls inside the fairing perimeter, wherein a system for cleaning and directing the ear into the machine houses the ear in projected links for the same to be transported upstream of the fairing, wherein it is unloaded in a thread or gimlet to enter the inner perimeter of the agricultural crop harvest machine or implement.

The present construction causes the sharp reap of the plant so that same tips over the area which determines the cut line, without an effective cleaning and disposal of parts of the crop that are not processed, such as, for example, leaves, stalks, among others. This causes these bodies that are foreign to the processing to be brought into the machine or implement, bringing a series of inconveniences and disadvantages.

In situ it was verified that among the most serious disadvantages of the devices and harvesting of an agricultural machine or implement the increase in weight over the platform and over the internal processing systems must be highlighted, which generates loss of equipment power. Another inconvenience is the fact that the leaves and residue of maize have a highly abrasive composition, which causes a premature wear of the mobile and processing sets of the agricultural machine or implement.

### SUMMARY OF THE INVENTION

Thus, it is the purpose of the present invention to provide an arrangement introduced in platform for agricultural crop harvest that removes the waste of the maize harvest so that the same does not enter the feeding and processing systems of the agricultural machine or implement.

An additional purpose of the invention is the provision of an arrangement introduced in platform for agricultural crop harvest, which eliminates the premature wear of the mobile sets and of the processing system of the agricultural machine or implement.

And finally, it is a purpose of the present invention the provision of an arrangement introduced in platform for agricultural crop harvest, which is easy to construct, install and at competitive costs.

These and other advantages are achieved with the provision of an arrangement introduced in platform for agricultural crop harvest, wherein the cutting and tipping system is conceived by a roll that is known from the state of the art, which installation is made slightly away from the beginning of the platform or the agricultural machine or implement. Said roll, particularly the first half thereof, has a shoulder with a helical pitch, whereby in the second half a rotary shaft is conformed. This shaft has coupling means for a series of fins, knives, or blades, by means of non-permanent connection, such as screws, pins. Alternatively, said fins, knives or blades can be welded on the roll itself, whereby this conformation, whether by junction or welding of one part to another, results in a part having three-dimensional configuration, wherein the fins, knives, or blades have a series of indentations, which project in longitudinal direction relative to the agricultural machine or implement.

The above-described arrangement causes, by means of rotary drive of the rolls, synchronously, the plant to be pulled down, causing the removal of all the residues, so that same do not enter the feeding and processing system of the agricultural machine or implement for crop harvest.

### BRIEF DESCRIPTION OF THE FIGURES

FIG. 1 Represents a perspective view of the knife or blade of the arrangement introduced in platform for agricultural crop harvest, object of the present invention.

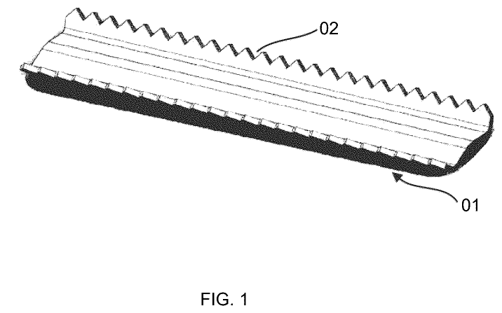

FIG. 2 Represents a perspective view of the upper portion of the knife or blade of the arrangement introduced in platform for agricultural crop harvest, object of the present invention.

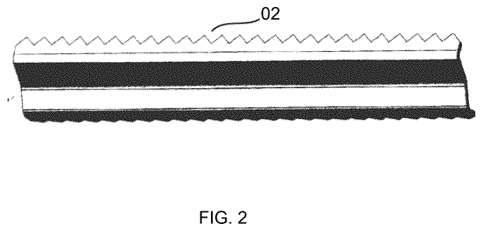

FIG. 3 Represents a perspective view of the knife or blade of the arrangement introduced in platform for agricultural crop harvest, object of the present invention.

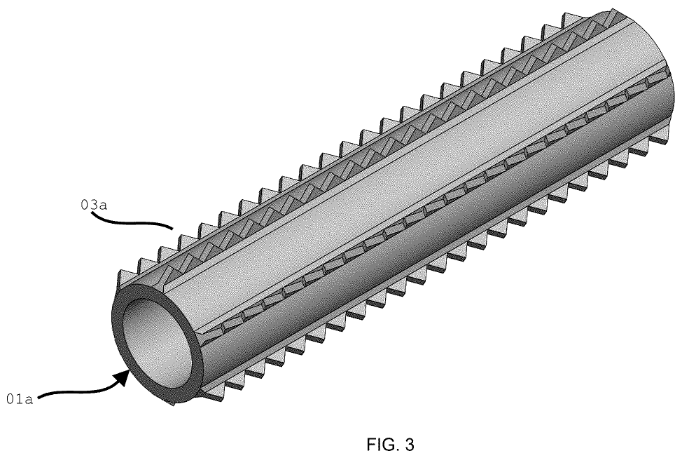

FIG. 4 Represents a perspective view of the upper portion of the knife or blade of the arrangement introduced in platform for agricultural crop harvest, object of the present invention.

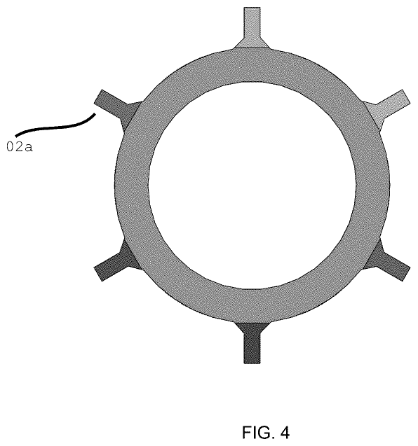

### DETAILED DESCRIPTION OF THE INVENTION

According to the above cited illustrations, and as already mentioned, the invention is applied to an agricultural machine or implement for agricultural crop harvest, more concretely maize, whereby said equipment is comprised of an automotive structure (not represented), which carries in its front portion a platform for cutting and gathering the maize. This platform is comprised of a chassis, constructed of steel beams or tubes, having means for coupling to an agricultural machine or implement, whereby it comprises in the transverse plane a plurality of fairings with conical configuration, distanced from each other, which allow the conformation between each one of these fairings of a harvest line. Under this fairing there is a set of conveyor chains which move upstream of the equipment, whereby in the course of said chains there are elongated links which transport the ears to the feeding system of the platform.

Below these chains, in each one of the lines there is arranged a set of plates, with selective opening, which allow adjustment so that the ear does not fall over the crop cultivation bed. Lower down on the agricultural machine or implement, slightly away from the soil there are arranged several sets of rolls installed side by side, whereby these have at their end a ledge projecting a helical pitch for directing the crop into the agricultural machine or implement.

The extension of the body of said roll is circular shaped, with bearings at the lower end of the platform and receiving a hydraulic or mechanical force transmission at the other, such as, for example, a gear set, a splined shaft, or other suitable coupling means. Whereby, from the second half of this roll there is projected a series of fins, knives, or blades, which during work receive rotary movements. These fins, knives, or blades are fixed to the roll by non-permanent connecting means, such as screws with nuts, rivets, or other suitable known means. Alternatively, the fins, knives, or blades can be conformed during the welding process of the roll itself, receiving thermal treatment for increasing surface hardness.

In the object of the present invention, these fins, knives, or blades (01) are conceived from a piece of raw metal, such as high performance alloy steels, having a three-dimensional configuration conformed in a manner compatible with the roll wherein it is installed. Whereby this part has in its perimeter portion a plurality of indentations, arranged in the longitudinal plane relative to the mounting direction of the fin, knife or blade (01) on the roll. The piece that is the object of the present invention can further undergo a treatment for increasing hardness, through quenching, austempering or tempering processes or other suitable thermal treatments. The fin, knife, or blade (01), can alternatively be submitted to localized surface hardness treatments by induction or flame on the border portions that are subject to greater wear by mechanical phenomena such as abrasion. The fin, knife, or blade (01) is fixed to the roll by non-permanent connecting means, such as screws, pins or other suitable means, such as, for example, mechanical fitting means arranged on the rolls themselves.

Alternatively, the fins, knives, or blades (01) can be conformed in the welding process of the roll itself, wherein they join the indentations on the perimeter of the part, whereby these may be submitted to the same thermal treatments previously described.

During work, the rolls with the fins, knives, or blades (01) installed or conformed to their perimeter, receive rotary movement from a mechanical or hydraulic transmission force, so that this rotation is synchronous among the parts that are side by side. Once the plant has entered the roll perimeter, the synchronous movements through the indentations will cause the plant to be projected from top to bottom, so that it is not decapitated and tips over the harvest line. This operation results in the plant being pulled from top to bottom, leaving a great part of the residues thereof on the soil, causing the feeding unit of the harvesting unit to only receive the ears and not leaves, stalks, and other parts, which, as already cited, cause friction through abrasion and premature wear, moreover, they add weight which demands power and consumption of the agricultural machine or implement.

In a second constructive form the device comprises a rotor (01a) applicable to a traction system of a plant in an agricultural perennial or annual crop harvesting unit, being characterized by the fact that it is formed from a welding, calendering or other known suitable process; a rotor (01a) from a piece of three-dimensional configuration with an elongated circular section, operatively associated to a helical pitch thread, whereby this piece has a plurality of knives or blades (02a) projected from the perimeter portion thereof, whereby the medium portions are straight relative to the geometrical axis of the piece and the remaining ones are inclined, having cutting edges (03a).

Having described the preferred configuration, it is obvious that eventual changes can occur in the forms or configurations of the fins, knives, or blades, without departing from the concept described in one or more claims which accompany the specification.

1-4. (canceled)

5. An agricultural crop harvesting unit platform roll comprising a fin, knife or blade, the fin, knife or blade projecting radially along a longitudinal plane of the platform roll, wherein the fin, knife or blade is formed from a raw metal plate and comprises a plurality of toothed indentations, wherein the raw metal plate is configured to conform and affix the fin, knife or blade to the roll.

6. The agricultural crop harvesting unit platform roll of claim 5, wherein the fin, knife or blade is permanently affixed to the roll.

7. The agricultural crop harvesting unit platform roll of claim 5, wherein the fin, knife or blade is thermally treated to increase surface hardness.

8. An agricultural crop harvesting unit platform rotor comprising an elongated circular section operatively associated to a helical pitch thread,
wherein the elongated circular section comprises a plurality of knives or blades which project radially along a geometrical axis of the elongated circular section,
wherein the plurality of knives or blades alternate between being straight or inclined relative to the geometrical axis of the elongated circular section, and
wherein the inclined plurality of knives or blades have cutting edges.
